(19) United States
(12) Patent Application Publication
(10) Pub. No.: US 2022/0138681 A1
(43) Pub. Date: May 5, 2022

(54) MACHINE LEARNING EVENT CLASSIFICATION AND AUTOMATED CASE CREATION

(71) Applicant: Convey, LLC, Austin, TX (US)

(72) Inventors: John Coleman Newell, Austin, TX (US); Jennifer Lynn Bebout, Austin, TX (US); Alexander James Moffat, Austin, TX (US)

(21) Appl. No.: 17/512,450

(22) Filed: Oct. 27, 2021

Related U.S. Application Data
(60) Provisional application No. 63/108,086, filed on Oct. 30, 2020.

(51) Int. Cl. G06Q 10/08; G06N 20/00

(52) U.S. Cl. CPC G06Q 10/0838; G06N 20/00

(57) ABSTRACT

Systems and methods for case management systems provide the ability to automatically create cases when issues are identified with shipments, to assign ownership to the created cases, and to communicate directly with internal or external teams. Embodiments include a system and method that uses machine learning (ML) models to determine shipment exception causes and dispositions. The case management system applies this, and other information to case rules to trigger the automatic creation of cases.

### CROSS-REFERENCE TO RELATED APPLICATION(S)

This application claims a benefit of priority under 35 U.S.C. § 119(e) from U.S. Provisional Application No. 63/108,086, filed Oct. 30, 2020, entitled “MACHINE LEARNING EVENT CLASSIFICATION AND AUTOMATED CASE CREATION,” which is fully incorporated by reference herein for all purposes.

### TECHNICAL FIELD

The present disclosure relates generally to computer systems for shipping management. More particularly the present disclosure relates to online computer systems for event classification and automated case creation.

### BACKGROUND

Retailers and other shippers of goods often outsource delivery to dedicated carriers. Many carriers provide online systems to allow shippers to schedule shipments and to provide shippers or intended recipients with in-transit tracking data that identifies when goods have passed through various designated tracking locations along the route. Organizations that do a large amount of shipping may implement a shipping management system that integrates with the carrier systems to facilitate shipping and shipment tracking. For example, commonly owned U.S. Pat. App. Pub. No. US-2019-0213548-A1, entitled “Unified View Operator Interface System and Method,” describes a multi-tenant shipping management system, and is fully incorporated by reference herein for all purposes.

However, such shipping management systems can suffer shortcomings with respect to case management and resolution. Some shipping management systems do not typically identify issues across multiple carriers because there is a lack of consistency across carriers and modes as to what constitutes an issue. In addition to the lack of consistency, shippers sometimes rely on the carriers to identify issues, and in some cases, the carriers do not flag all issues or potential issues. In addition, carriers do not always provide such information in a timely manner (or fail to identify some issues at all). Accordingly, potential issues are often not exposed to shippers or exposed to shippers in a timely manner that would allow the shipper or recipient to manage cases resulting from the issues or potential issues in an efficient manner.

Therefore, there is a need for case management systems that provide the ability to create cases when issues are identified with shipments, to assign ownership to the identified cases, and to communicate directly with internal or external teams.

### SUMMARY

Systems and methods are described for creating cases in a shipping management system. In some embodiments, the method includes receiving event and exception information relating to a plurality of shipments, normalizing the event and exception information, determining an exception cause and disposition for a given exception by applying inputs to one or more machine learning models trained to output exception causes and dispositions, and automatically creating cases by applying one or more case rules to the event and exception information.

Embodiments of the present invention also include computer-readable storage media containing sets of instructions to cause one or more processors to perform the methods, variations of the methods, and other operations described herein.

These, and other, aspects of the disclosure will be better appreciated and understood when considered in conjunction with the following description and the accompanying drawings. It should be understood, however, that the following description, while indicating various embodiments of the disclosure and numerous specific details thereof, is given by way of illustration and not of limitation. Many substitutions, modifications, additions and/or rearrangements may be made within the scope of the disclosure without departing from the spirit thereof, and the disclosure includes all such substitutions, modifications, additions and/or rearrangements.

### BRIEF DESCRIPTION OF THE FIGURES

The drawings accompanying and forming part of this specification are included to depict certain aspects of the invention. A clearer impression of the invention, and of the components and operation of systems provided with the invention, will become more readily apparent by referring to the exemplary, and therefore nonlimiting, embodiments illustrated in the drawings, wherein identical reference numerals designate the same components. Note that the features illustrated in the drawings are not necessarily drawn to scale.

FIG. 1 is a screenshot showing an example of a user interface encountered when a user creates a new rule.

FIG. 2 is a screenshot of a user interface showing a rule summary.

FIGS. 3-4 are screenshots of a user interface showing a list of rules.

FIG. 5 is a screenshot of a user interface showing a created case.

FIG. 6 shows a screenshot of an activity feed showing the automatic creation of a case.

FIGS. 7-8 are block diagrams illustrating examples of intelligent carrier exception classification.

FIG. 9 illustrates exemplary information relating to the current state of an exception.

FIG. 10 is a diagram illustrating an enhanced exception concept.

FIG. 11 illustrates exemplary information relating to a change to a current state of shipment events, including exception details such as the cause and disposition.

FIG. 12 shows an end state of shipment events, including a set of possible exception details.

FIG. 13 shows a diagram illustrating an example of possible combinations of exception type, exception cause, and exception disposition used to classify an exemplary exception.

FIG. 14 is a block diagram illustrating an example of a status classification service working with a shipment pipeline to automatically create cases.

FIG. 15 is a flow chart depicting a process for automatically creating cases.

FIG. 16 is a diagrammatic representation of one embodiment of a distributed network computing environment.

### DETAILED DESCRIPTION

The invention and the various features and advantageous details thereof are explained more fully with reference to the non-limiting embodiments that are illustrated in the accompanying drawings and detailed in the following description. Descriptions of well-known starting materials, processing techniques, components and equipment are omitted so as not to unnecessarily obscure the invention in detail. It should be understood, however, that the detailed description and the specific examples, while indicating some embodiments of the invention, are given by way of illustration only and not by way of limitation. Various substitutions, modifications, additions and/or rearrangements within the spirit and/or scope of the underlying inventive concept will become apparent to those skilled in the art from this disclosure.

Generally, the present disclosure describes systems and methods for case management systems that provide the ability to automatically create cases when issues are identified with shipments, to assign ownership to the identified cases, and to communicate directly with internal or external teams.

As discussed above, retailers and other shippers of goods often outsource delivery to dedicated carriers. Case management systems can be used by shippers and carriers to create cases when issues are identified with shipments, to assign ownership, and to communicate directly with internal or external teams. In some embodiments, case management can be viewed and configured in a shipping management system on the same page where all the relevant order, shipment, and customer information is located to maximize efficiency. Logistics and customer care leaders can also view the activities of their team on powerful, interactive dashboards to help load balance their teams and optimize productivity.

Embodiments described herein provide a case management system that enables automated case creation, routing, and resolution, based on event classifications that are generated (e.g., utilizing machine learning (ML), discussed below) to diagnose problems and interpret tracking events. The disclosed system provides a means to help users with proactive exception management. For example, looking at shipments in transit, exemplary rules can be provided that effectively say “find shipments like X,” (where X is a set of conditions or events), then raise the issue, so that a workflow exists to help someone solve the problem caused by the triggering event. In some embodiments, rules can also be created that automatically generate exceptions based on information such as dates or times. For example, while on one hand, rules can be triggered based on a status change or event, rules can also be triggered based on the amount of time that has elapsed since a previous event/trigger/etc. For example, commonly owned U.S. Pat. App. Pub. No. US-2018-0165635-A1, entitled “Systems and Methods for Predictive In-Transit Shipment Delivery Exception Notification and Automated Resolution,” describes a multi-carrier shipping management with predictive exceptions and exception resolution, and is fully incorporated by reference herein for all purposes.

As described in more detail below, in some examples, certain shipment events can be tagged with exceptions. For example, a common exception is “shipment damaged.” Rules can be created and managed that can address issues by automatically creating exceptions. In the example, above, a rule could be created that generates an exception when a package is damaged, so the problem can be addressed proactively.

As mentioned above, case management systems can be used by shippers and carriers to create cases when issues are identified with shipments, to assign ownership, and to communicate directly with internal or external teams. For shippers, a case management system enables logistics and customer care teams to be able to quickly escalate any shipping issue into a case and instantly pull in the most appropriate carrier support person or respond to a carrier's request for disposition more efficiently. Benefits of this include more efficient logistics and customer care teams, increased customer satisfaction by resolving shipping issues faster, and less incurred costs by avoiding charges related to changes in delivery and storage. With respect to carriers, many carriers do not have a case or ticket tracking system. These carriers are forced to track emails or add notes to asset management systems in order to keep track of the escalations and actions with customers. Carriers may gain access to information through their shippers who are utilizing case management systems so that they can better serve their customers. Benefits of this include more efficient customer care teams, more loyal shipper relationships, increased customer satisfaction by resolving shipping issues faster, reduction of shipments clogging up terminals while waiting for resolution, and increased revenue by enabling capacity for more shippers.

In a case management system, cases can be created in multiple ways. For example, cases can be created by a user on a shipment details page of the case management system, by a user on a case management page, by a rule automatically (described below), by sending an email to a company's case email addresses, by an API, etc. Other examples of case creation are also possible, as one skilled in the art would understand.

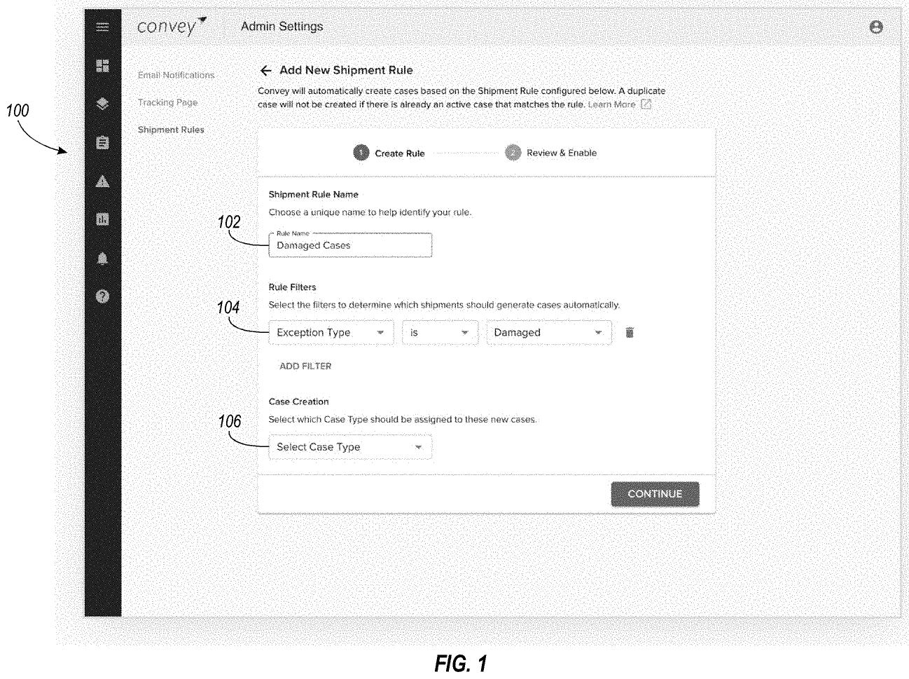

Following is a description of an embodiment for creating cases automatically using shipment rules. In some embodiments, a case management system allows users to access and configure shipment rules and settings. For example, a user of the case management system may create new shipment rules. In this example, a user may select filters to determine which shipments should automatically trigger a case. The user can name the rule and select which case type will be assigned to these new cases. FIG. 1 is a screenshot showing an example of a user interface 100 encountered when a user creates a new rule. As shown in this example, the interface 100 provides interfaces where a user can create a filter name 102, configure rule filters 104, and select case types 106. Other case creation configuration options can also be provided, as one skilled in the art would understand.

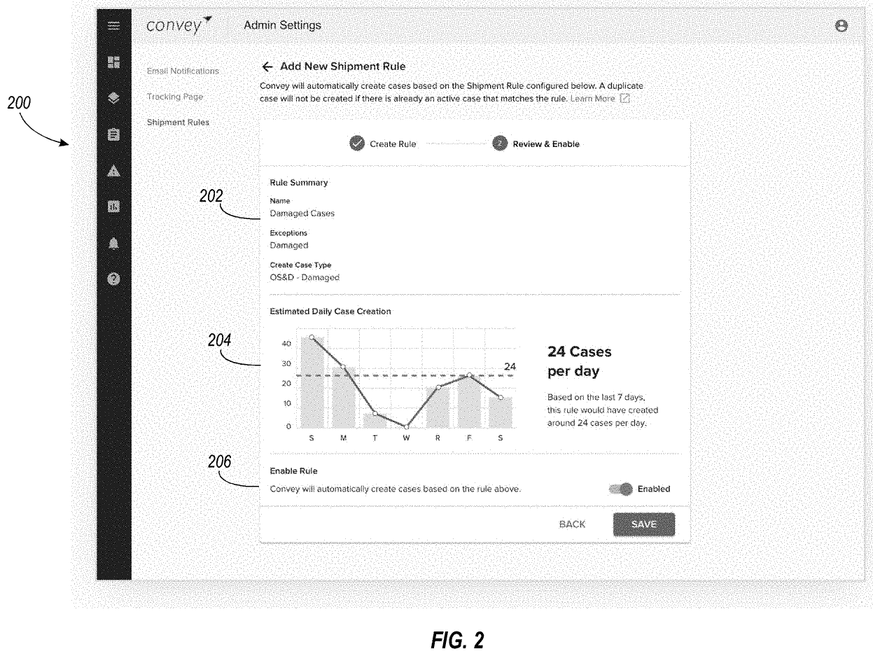

Upon the creation of a rule, the user will see a preview of how many cases the system estimates will be created based on the filters selected. This can be calculated, for example, using historical data and displays how many cases would have been created the past 7 days (or over some other time period). If ready, the user can click to enable the rule, or can save it without enabling it, and enable it at a later time. FIG. 2 is a screenshot of a user interface 200 showing a rule summary 202, including an estimated daily case creation rate 204, and an enable rule toggle 206. In this example, an estimated case creation rate is provided in the form of a bar graph showing estimated cases that would be created by the rules, based on data from the previous seven days.

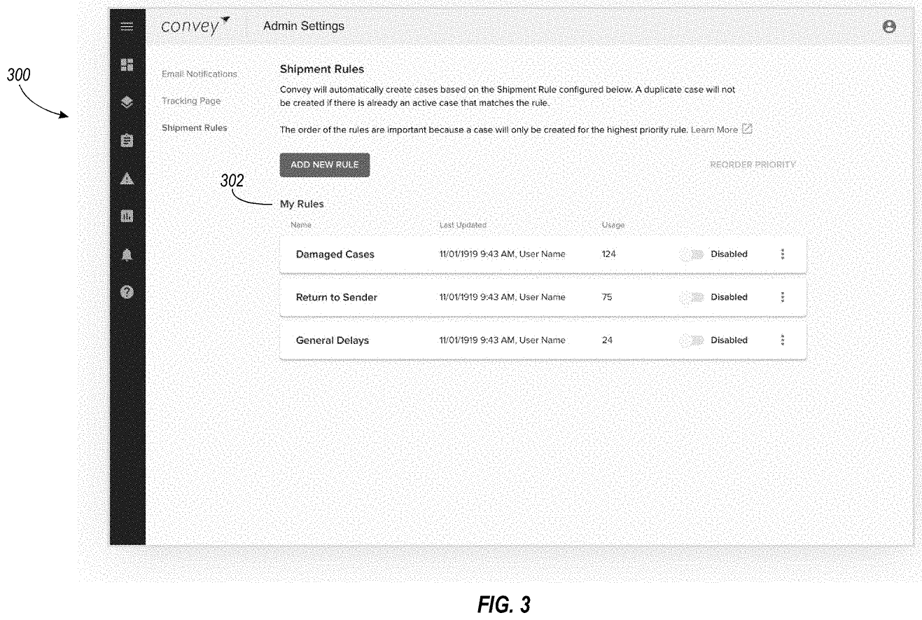

In some examples, an interface can be provided where each of a user's rules may be displayed as a card, which can be toggled between “Enable” or “Disable.” The system may also display information about who updated the rule last and when, and how many times this rule triggered a case over a given time period (e.g., in the last 7 days). A user may edit or delete any of these rules. FIG. 3 is a screenshot of a user interface 300 showing a list of rules 302, including information (as discussed above) such as rule name, rule update data, rule usage, and an enable/disable toggle.

The system enables users to reorder the priority of the rules, for example, by clicking the button and dragging the cards up and down. The order of these rules may be important since the system may only create a case for the highest priority rule that matches, as desired. FIG. 4 is a screenshot of the user interface 300 of FIG. 3, showing a user adjusting the order of rules. In this example, the user is adjusting the order of the rules 302 by dragging a rule up or down in the list of rules. Other techniques for adjust the order of rules may also be utilized.

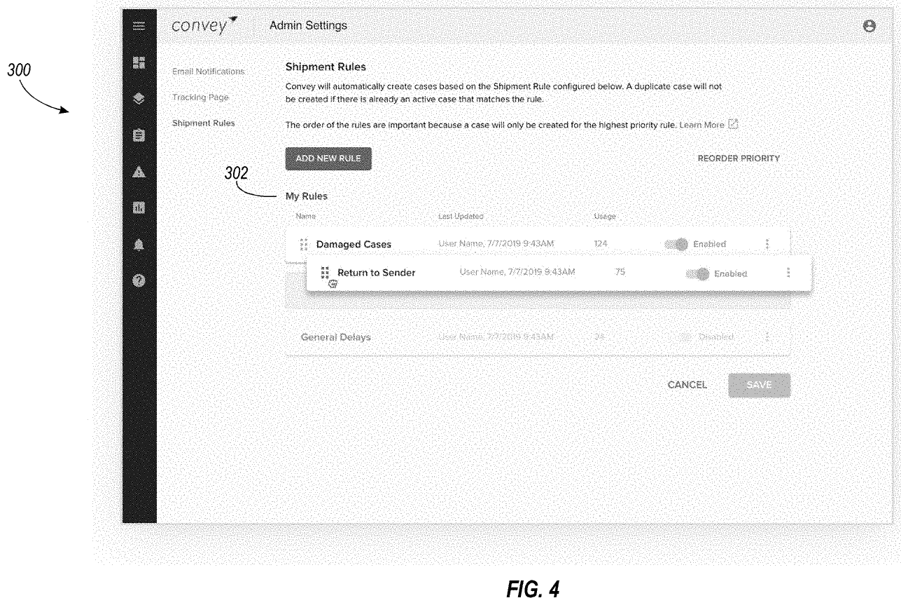

In some embodiments, when a case is created from a rule, it will show up on a left hand panel of a new shipment details view of the case management system. A user may navigate to the panel from both the shipments and cases pages of the case management system. FIG. 5 is a screenshot of a user interface 500 showing a created case 502 (highlighted in the left panel) of a shipment details view. The interface shows various details of the created case, such as an identifier, a status (e.g., active, solved, etc.), a case type, a shipper and/or carrier identification, a case owner, a case watcher(s), etc. Other details may also be shown, as desired.

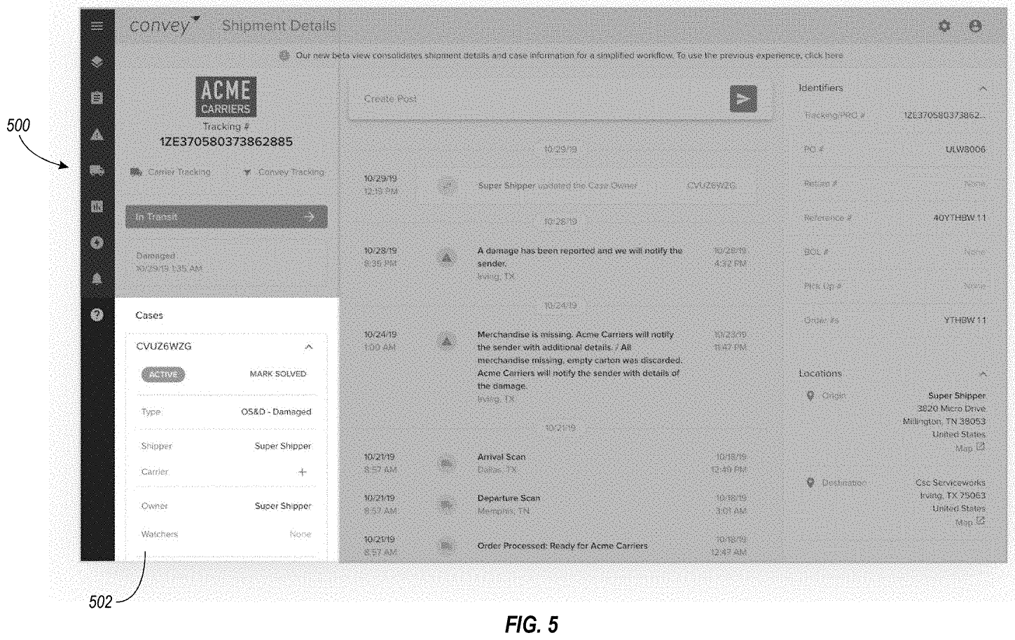

In some embodiments, a user of a case management system can tell if a case was created by a shipment rule on the shipment details page, because it will display a special event in an activity feed. FIG. 6 shows a screenshot 600 of an activity feed showing the automatic creation of a case. The activity feed item shown in FIG. 6 shows information such as a time/date stamp, the case type (“Return to Sender”), the source of the automatically created case (“Shipment Rules”), and a case identifier. An activity feed (or any other type of notification) can include any other desired case information, as one skilled in the art would understand. In some embodiments, the case may also be shown in a case details section of the case management system.

When a case is automatically created, its creation may be based on an event classification. An event may be classified to help diagnose problems and interpret tracking events. In some examples, identifying status updates and exceptions provides enough information for the system. In other examples, the system utilizes machine learning to intelligently classify event data into an actionable taxonomy to identify the underlying problem and to illuminate the path to resolution.

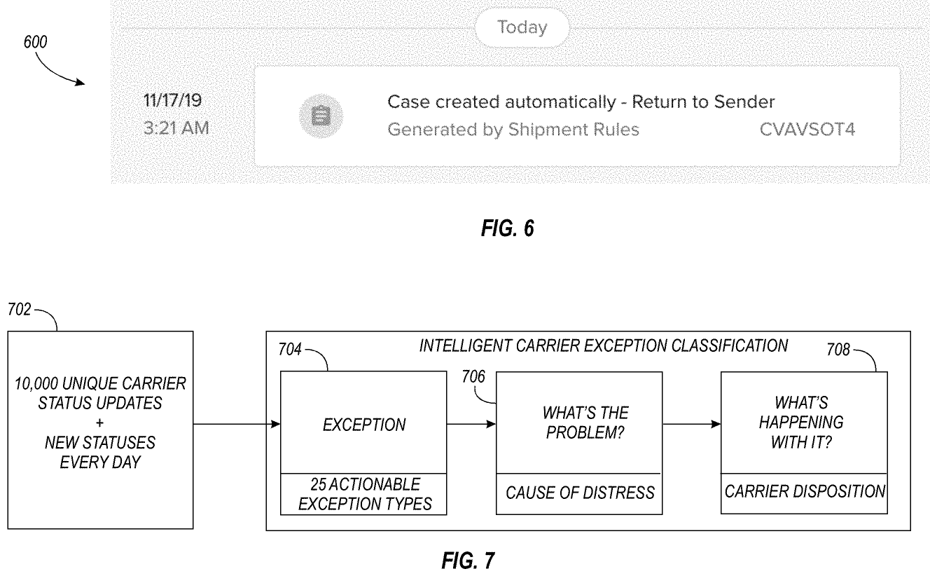

FIG. 7 is a block diagram illustrating an example of intelligent carrier exception classification. As shown, the system is provided with numerous unique carrier status updates and new statuses (block 702). When an exception is encountered (e.g., actionable exception types) (block 704), the system determines the cause of the problem (“Cause of Distress”) (block 706), and may determine how it should be handled (“Carrier Disposition”) (block 708).

In some embodiments, a model is provided with input data and generates (using ML) desired output information. Input data can include various information available to the system. For example, input data can include data such as the identity of the carrier (e.g., FedEx, UPS, USPS, etc.), a service level (e.g., 2nd day air, express air, ground, etc.), a status code from the carrier, an exception code from the carrier, a status description (e.g., a text field), and various available metadata (e.g., residential vs. commercial delivery, etc.). The model may use information from a single event, or from a set of historical events. For example, if a certain exception has occurred multiple times recently, it may be handled differently than if it were the first occurrence. In one example, the model provides an output, including a status and an exception. Other outputs are also possible.

FIG. 8 is a block diagram illustrating an example of an intelligent exception classification, using the steps shown in FIG. 7. Block 802 represents numerous unique exception codes that can be received by a case management system, as well as a status. In the example of FIG. 8, an “incorrect address” exception is encountered (block 804). The same base issue may be caused by numerous factors (e.g., an incorrect street number), with a status shown accordingly. In this example, the problem causing the actionable exception (incorrect address) is identified (block 806). Examples of problems causing this actional exception may include a missing apartment number, missing street number, delivery to a wrong address, incorrect contact information, a recipient moved, etc. In this example, the carrier disposition is shown at block 808. For example, the carrier disposition may include awaiting information, returned to sender, scheduled next day, contacting receiver. corrected, available for pickup, delivered, etc.

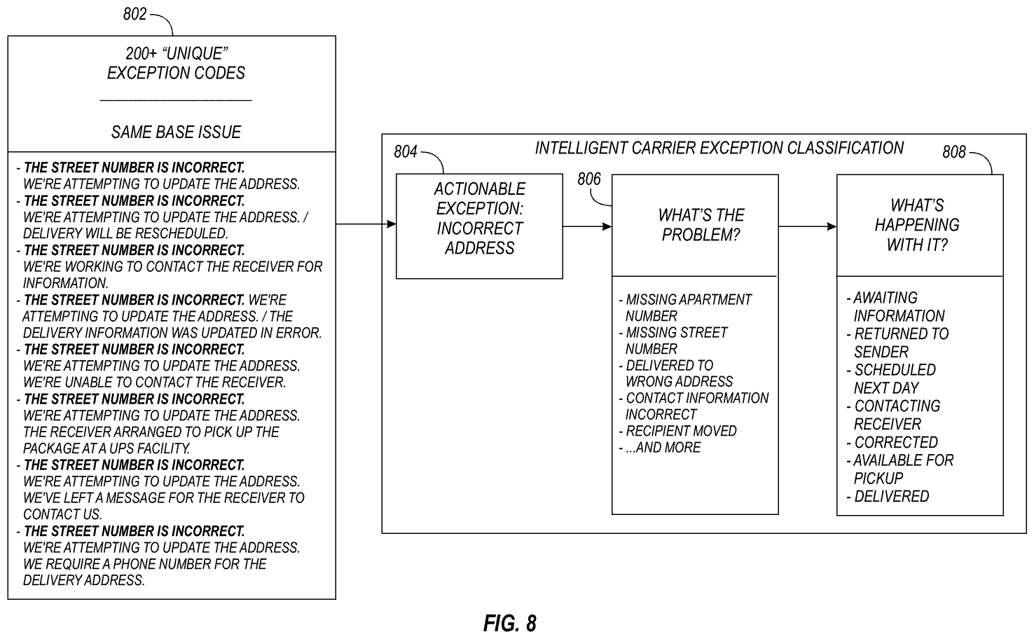

Sometimes, singular high-level exception labels are not specific enough to recover from without further investigation into each shipment. The system disclosed herein enables automation, large scale workflow, and bulk action in response to exceptions. FIG. 9 illustrates exemplary information relating to the current state of an exception. A given exception can have a current status, an exception type, and a milestone(s). For example, FIG. 9 lists several exemplary exception status codes and their corresponding meanings (e.g., B—Scheduled, T—In Transit, O—Out for Delivery, D—Delivered, U—Unknown, S—Delivered to Sender, C—Canceled, R—Returning to Sender, Q—Quoted, X—Undeliverable, N—New, K—Pickup Appointment, etc.). FIG. 9 also shows several examples of exception types, including Attempted Delivery, Shipment Label Replaced, Available for Pickup, other, general delay, weather delay, incorrect address, street, apt, contact information, incorrect name, delivered to wrong address, recipient moved, return to sender (RTS), customer change request, damaged or shorted, short, schedule appointment, tendered late, held at terminal, reconsigned, consignee refused, convey revised EDD later, no attempt made scheduled next day, lost, shipment correction, remote address, unable to track, disposed, service approval, etc. FIG. 9 also shows several examples of case milestones, including Picked-up Date & Location, Arrived at Origin Terminal Date & Location, Departed Origin Terminal Date & Location, Middle-mile Terminal Scans Dates & Locations, Customer Contacted for Appointment Date, Appointment Scheduled/Set Date, Arrived at Final Mile Hub Date & Location, Out for Delivery Date & Location, Delivery Attempt Date & Location, Delivered Date & Location, etc. For the purposes of this description, a “milestone” is more detailed version of the status that is determined by the system (rather than a status provided by a carrier). For example, a status may be “in transit”, while a milestone provides more detail than just “in transit.”

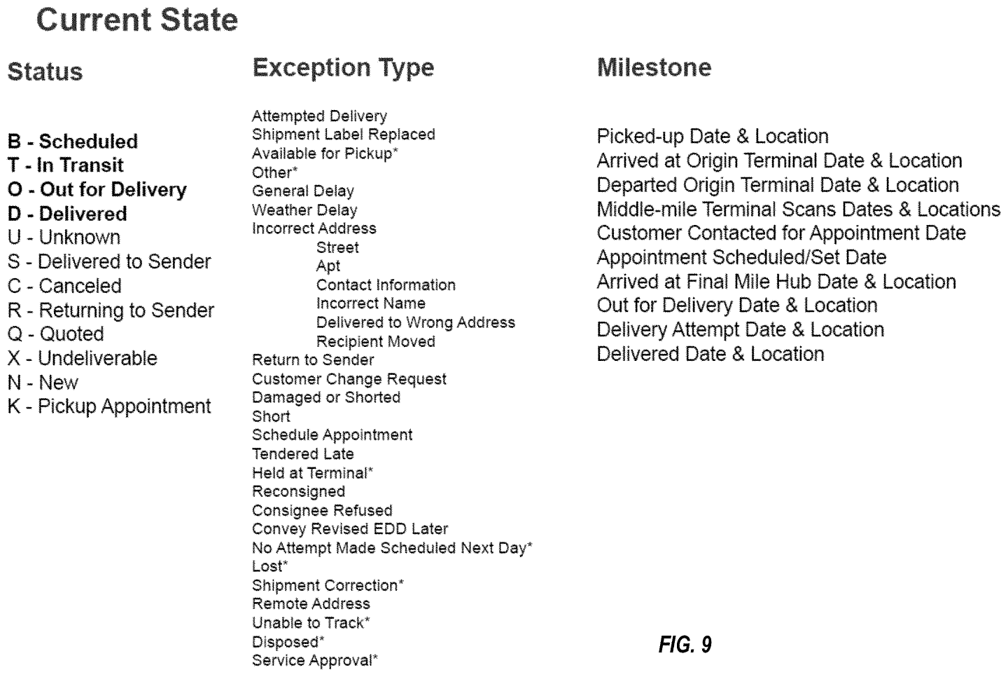

Additional descriptor fields can be added to the data model of carrier tracking events in some embodiments. For example, in some embodiments, two new complementary fields enhance exception recovery. The system aims to deliver actionable insight into the problem and illuminate the path to resolution. In some embodiments, the system replaces legacy exception mapping with machine learning models. FIG. 10 is a diagram illustrating this enhanced exception concept. In this example, an original exception type 1002 is enhanced by adding two new complementary fields 1004 and 1006. The first complementary field 1004 relates to the cause of the distress (“What's the problem?”), and the second complementary field 1006 relates to the carrier disposition (“What's happening with it?”). Examples of these complementary fields were provided above. In other examples, more or less complementary fields can be used, as one skilled in the art would understand.

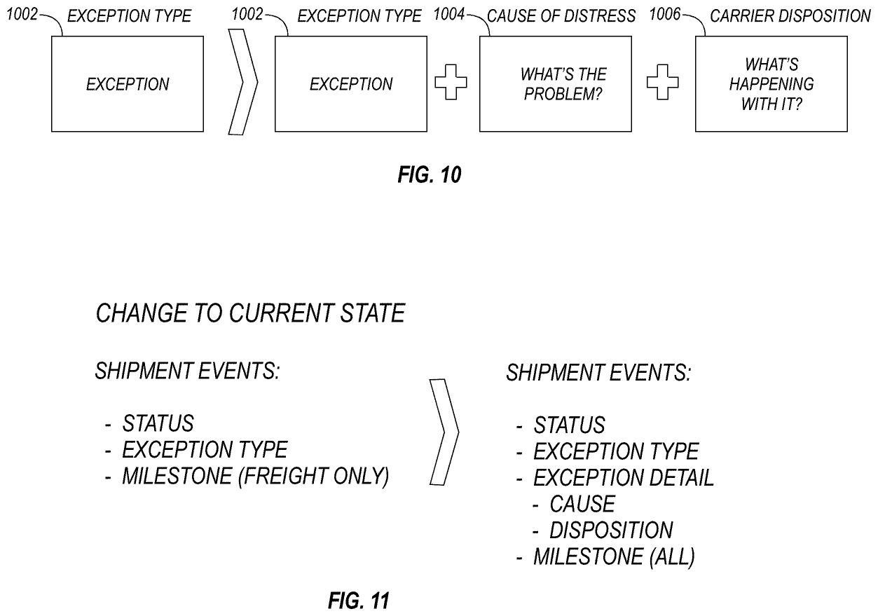

FIG. 11 illustrates exemplary information relating to the change to the current state of shipment events, including exception details such as the cause and disposition. In the example of FIG. 11, the initial shipment events (states) are “Status,” “Exception type,”, and “Milestone (Fright only).” As shown, additional information is included in the shipment events, such as exceptions details (e.g., cause and disposition) and all milestones. Other examples are also possible.

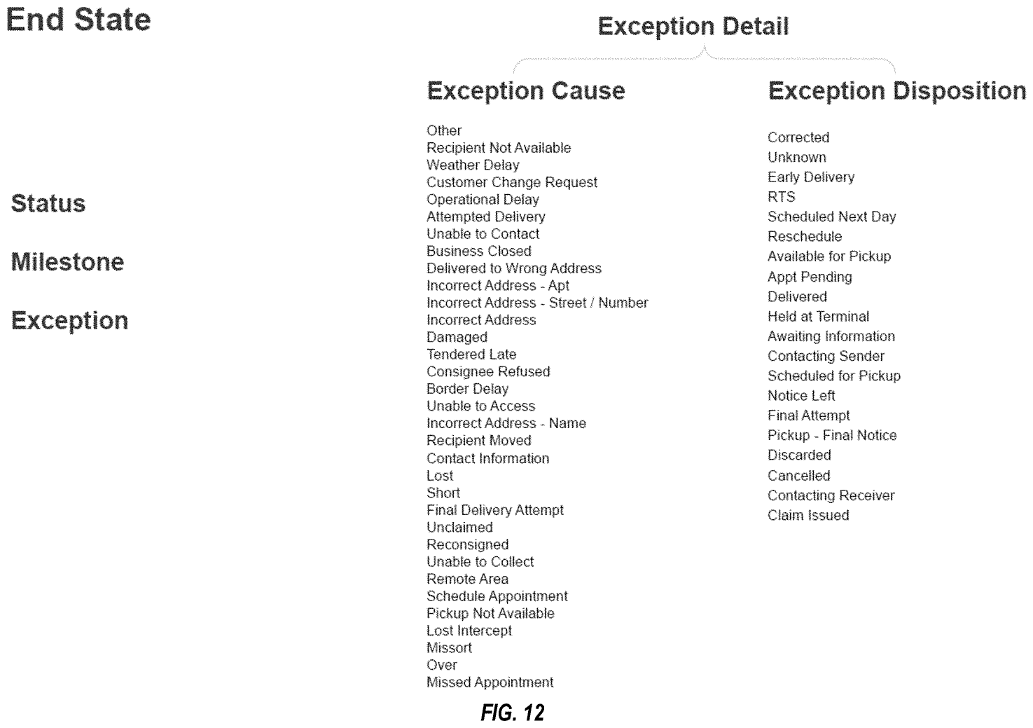

Similarly, FIG. 12 shows the end state of shipment events (e.g., “Status,” “Milestone,” “Exception”), including a set of possible exception details, such as exception causes and exception dispositions. For example, FIG. 12 lists several exemplary exception causes, (e.g., Other, Recipient Not Available, Weather Delay, Customer Change Request, Operational Delay, Attempted Delivery, Unable to Contact, Business Closed, Delivered to Wrong Address, Incorrect Address—Apt, Incorrect Address—Street/Number, Incorrect Address, Damaged, Tendered Late, Consignee Refused, Border Delay, Unable to Access, Incorrect Address—Name, Recipient Moved, Contact Information, Lost, Short, Final Delivery Attempt, Unclaimed, Reconsigned, Unable to Collect, Remote Area, Schedule Appointment, Pickup Not Available, Lost Intercept, Missort, Over, Missed Appointment). FIG. 12 also lists several exemplary exception dispositions, (e.g., Corrected, Unknown, Early Delivery, RTS, Scheduled Next Day, Reschedule, Available for Pickup, Appt Pending, Delivered, Held at Terminal, Awaiting Information, Contacting Sender, Scheduled for Pickup, Notice Left, Final Attempt, Pickup—Final Notice, Discarded, Canceled, Contacting Receiver, Claim Issued).

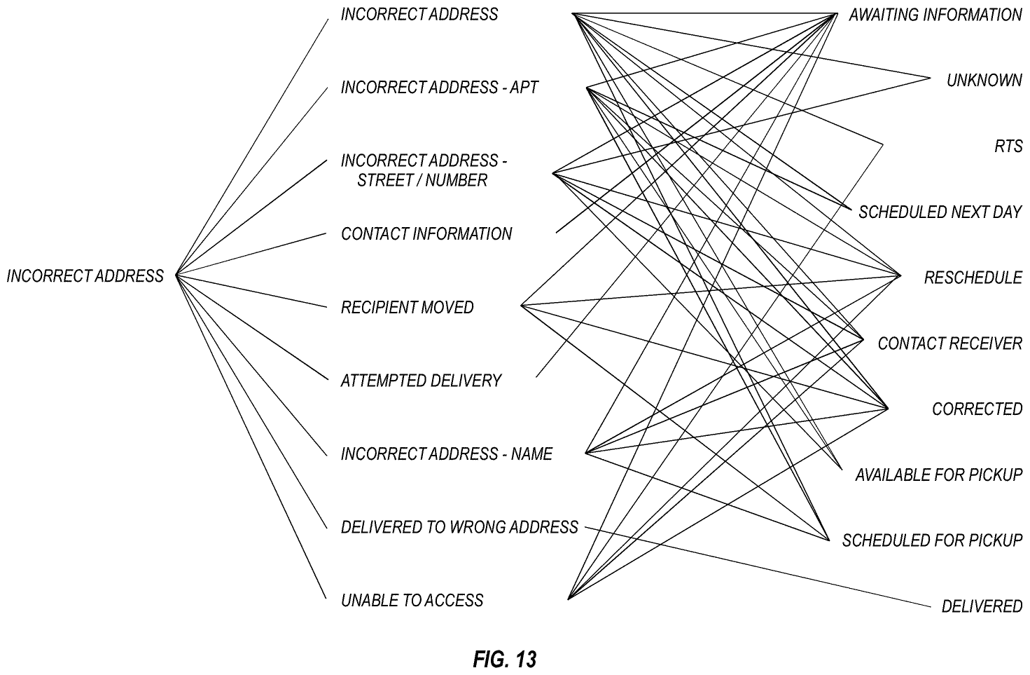

FIG. 13 shows a diagram illustrating an example of possible combinations of exception type, exception cause, and exception disposition used to classify an incorrect address exception. In the example of FIG. 13, the diagram shows the “incorrect address” exception on the left. For a given incorrect address exception, the cause is determined. The center column in FIG. 13 shows examples of causes. In this example, exemplary causes include an incorrect address, an incorrect apartment number, an incorrect street, etc. The right side of FIG. 13 shows possible exception disposition statuses. Exemplary disposition statuses include awaiting information, unknown, RTS, etc. The use of compound descriptor fields dramatically increases the number of possible, in this case, 90 possible cause-disposition combinations for one exception type). FIG. 13 illustrates possible disposition statuses for each given cause of the exception. Similar diagrams could show relationships between other exceptions, causes, and dispositions, as one skilled in the art would understand. FIG. 13 is one example illustrating the results of enhanced exception machine learning. In some embodiments, there can be numerous unique combinations of exception causes and dispositions. As discussed above, the system is capable of covering multiple carriers across both freight and parcel services.

The disclosed system provides numerous benefits and advantages. For example, the system is capable of triaging events into specific recovery actions and interpret insights such as “return to sender risk” or “awaiting information.” Also, the system can also provide recovery paths to exceptions that may be ignored by conventional systems. For some exceptions, it is difficult to provide a path to recovery. However, the system described herein provides enough information to recover from exceptions that may otherwise be ignored (for example, the exception “other”, which may be a common exception that gets ignored by conventional systems). The system also provides the ability to use custom alerting to send targeted alerts. The system also can provide case rules that enable features such as to triage and create the first message of a case based on problem details. The system also can enable bad mapping detection and highlight conflicting exception tags. The system also enables high volume and enterprise users to send detailed alerts. For example, alerts or reports can be sent to customers, such as “these 30 shipments received a final notice that the package has been held for pick up for too long, and will soon be returned to sender.” This allows customers or carriers to be alerted with an appropriately urgent message.

In some embodiments, when creating case rules, the rule can be specific enough that there is no unnecessary workflow created. For example, certain incorrect address exceptions should only create a case if they are uncorrected, or not already rescheduled. Another feature relating to case automation is to incorporate the correct shipment details and case message when creating cases. The system can point to specific appropriate messages for each distinct exception type and route those messages to the correct party.

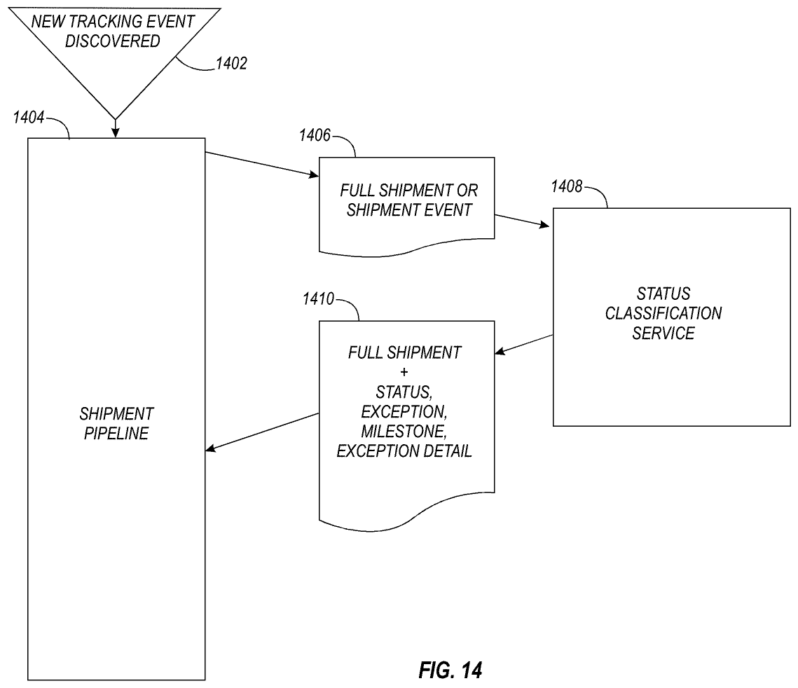

FIG. 14 is a block diagram illustrating an example of a status classification service working with a shipment pipeline to implement the items discussed above. In the example illustrated in FIG. 14, new tracking event information is discovered (1402) and is provided to the shipment pipeline (1404). In some embodiments, a shipping management system discovers a given customer's outbound shipments. Full shipment or shipment event information (1406) is provided to the status classification service (1408). The status classification service then provides (as described in detail above) full shipment information plus status, exception, milestone, and exception details (1410) to the shipment pipeline (1404) for use as described above.

In some embodiments, to support automation, each exception is classified to a level of detail that points to one singular recovery action in the backend. In some embodiments, the front end of the system does not have to reflect the backend of the system. For example, the front end may abstract the levels of detail into more digestible groupings like legacy exceptions or new insights such as “return to sender risk” (discussed above). The system can still highlight these detailed breakdowns when it is helpful, for example, for exception reporting. Workflows rely heavily on exceptions as currently defined, and the present system provides this information.

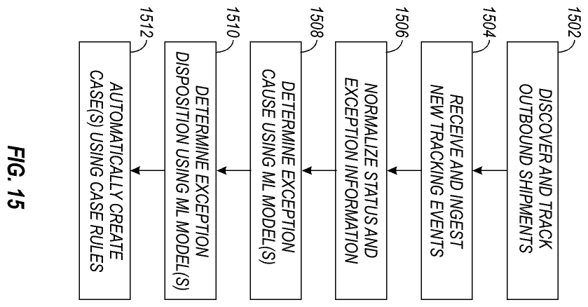

FIG. 15 is a flow chart depicting a process for automatically creating cases, as discussed above. As discussed above, at step 1502 outbound shipments are discovered and tracked. The discovered outbound shipments may each include a unique identifier, which allows the system to continue to track shipments to get the latest information (e.g., new status, status description, exceptions, exception descriptions, etc.) relating to respective shipments throughout the shipping process. As discussed in more detail below, the system will receive ingest the new tracking events (step 1504), and together with other information, will develop an understanding the latest status of respective shipments. Since shipments may come from different carriers, the shipping management system will normalize the status and exception information (step 1506). A shipment's status, status description, exceptions, and exception descriptions may all be normalized by the system.

As discussed above, one or more ML models are developed and trained to output information relating to exception causes and exception dispositions. For example, a first ML model is trained to take input data for a shipment and generate an exception cause. Inputs to this ML model may include information about a tracking event (e.g., the carrier, the event description, the event status code, information about previous events for the shipment, etc.). Similarly, a second ML model is trained to take input data for a shipment and generate an exception disposition (i.e., what is needed to resolve an exception). Inputs to this ML model may be the same as the first ML model. ML models may use any desired inputs, as one skilled in the art would understand. The ML models may be trained using historical shipping data, or any other data available.

At step 1508, an exception cause (examples are described above) is determined using a ML model, such as the first ML model described above. At step 1510, an exception disposition (examples are described above) is determined using a ML model, such as the second ML model described above. Also note, as described above, a shipping management system can create predictive exceptions, in addition to relying on exceptions and events originating from carriers.

At this point, a case management system may have, for a given shipment, information relating to the shipment, including a status and description, an exception and description, a predictive exception, an exception cause, and an exception disposition. At step 1512, the case management system automatically create a case by applying this information as inputs to case rules. As described above, cases can be created when the underlying conditions trigger one or more of the case rules.

Once a case is created, the case can be resolved in any desired manner, as one skilled in the art would understand. In some embodiments, a case management system can automatically resolve some cases or triage a case into specific recover actions. In one example, if the criteria that triggered a case rule to create a case is no longer true, than the case management system can mark a case as resolved. In other examples, if an exception is capable of being resolved automatically, the case management system can take the necessary steps to resolve the case. Similarly, the case management system can automate some processes in response to an automatically created case. For example, based on the case rules, case information can be assigned to a person, and the case information can be placed in a queue, and/or messages can be generated for the assigned person.

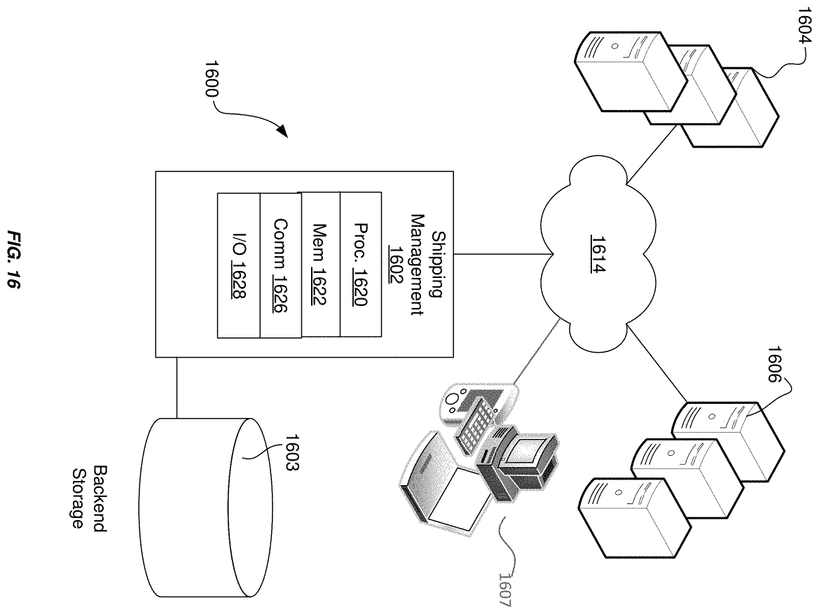

FIG. 16 is diagrammatic representation of a distributed network computing environment 1600 where embodiments disclosed can be implemented. In the example illustrated, network computing environment 1600 includes network 1614 that can be bi-directionally coupled to shipping management platform system 1602, shipper computer systems 1604, carrier computer systems 1606, and recipient computer systems 1607. Network 1614 may represent a combination of wired and wireless networks that network computing environment 1600 may utilize for various types of network communications known to those skilled in the art. Shipping management platform system 1602 can be bi-directionally coupled to a data store 1603 storing a searchable collection of normalized shipping records, associated event records, shipper digital assets, scheduling records, rules and mappings.

For the purpose of illustration, a single system is shown for shipping management platform system 1602. However, shipping management platform system 1602 may comprise a plurality of computers (not shown) interconnected to each other over network 1614.

Shipping management platform system 1602 may include, for example, a computer processor 1620 and associated memory 1622. Computer processor 1620 may be an integrated circuit for processing instructions. For example, processor 1620 may comprise one or more cores or micro-cores of a processor. Memory 1622 may include volatile memory, non-volatile memory, semi-volatile memory, or a combination thereof. Memory 1622, for example, may include RAM, ROM, flash memory, a hard disk drive, a solid-state drive, an optical storage medium (e.g., CD-ROM), or other computer readable memory or combination thereof. Memory 1622 may implement a storage hierarchy that includes cache memory, primary memory, or secondary memory. In some embodiments, memory 1622 may include storage space on a data storage array. Shipping management platform system 1602 may also include I/O devices 1626 and a communication interface 1628, such as a network interface card, to interface with network 1614. Memory 1622 may store instructions executable by processor 1620. For example, memory 1622 may include code for a shipping management application, a data ingestion engine, or other code executable to provide a shipping management platform, such as shipping management platform 110, or component thereof. For the sake of brevity, shipping management computer system 1602 is illustrated as having one of each of the hardware components, even if more than one may be used.

Those skilled in the relevant art will appreciate that the invention can be implemented or practiced with other computer system configurations including, without limitation, multi-processor systems, network devices, mini-computers, mainframe computers, data processors, and the like. Embodiments can be employed in distributed computing environments, where tasks or modules are performed by remote processing devices, which are linked through a communications network such as a LAN, WAN, and/or the Internet. In a distributed computing environment, program modules or subroutines may be located in both local and remote memory storage devices. These program modules or subroutines may, for example, be stored or distributed on computer-readable media, including magnetic and optically readable and removable computer discs, stored as firmware in chips, as well as distributed electronically over the Internet or over other networks (including wireless networks). Example chips may include Electrically Erasable Programmable Read-Only Memory (EEPROM) chips. Embodiments discussed herein can be implemented in suitable instructions that may reside on a non-transitory computer readable medium, hardware circuitry or the like, or any combination and that may be translatable by one or more server machines. Examples of a non-transitory computer readable medium are provided below in this disclosure.

Although the invention has been described with respect to specific embodiments thereof, these embodiments are merely illustrative, and not restrictive of the invention. Rather, the description is intended to describe illustrative embodiments, features and functions in order to provide a person of ordinary skill in the art context to understand the invention without limiting the invention to any particularly described embodiment, feature or function, including any such embodiment feature or function described. While specific embodiments of, and examples for, the invention are described herein for illustrative purposes only, various equivalent modifications are possible within the spirit and scope of the invention, as those skilled in the relevant art will recognize and appreciate.

As indicated, these modifications may be made to the invention in light of the foregoing description of illustrated embodiments of the invention and are to be included within the spirit and scope of the invention. Thus, while the invention has been described herein with reference to particular embodiments thereof, a latitude of modification, various changes and substitutions are intended in the foregoing disclosures, and it will be appreciated that in some instances some features of embodiments of the invention will be employed without a corresponding use of other features without departing from the scope and spirit of the invention as set forth. Therefore, many modifications may be made to adapt a particular situation or material to the essential scope and spirit of the invention.

Reference throughout this specification to “one embodiment”, “an embodiment”, or “a specific embodiment” or similar terminology means that a particular feature, structure, or characteristic described in connection with the embodiment is included in at least one embodiment and may not necessarily be present in all embodiments. Thus, respective appearances of the phrases “in one embodiment”, “in an embodiment”, or “in a specific embodiment” or similar terminology in various places throughout this specification are not necessarily referring to the same embodiment. Furthermore, the particular features, structures, or characteristics of any particular embodiment may be combined in any suitable manner with one or more other embodiments. It is to be understood that other variations and modifications of the embodiments described and illustrated herein are possible in light of the teachings herein and are to be considered as part of the spirit and scope of the invention.

In the description herein, numerous specific details are provided, such as examples of components and/or methods, to provide a thorough understanding of embodiments of the invention. One skilled in the relevant art will recognize, however, that an embodiment may be able to be practiced without one or more of the specific details, or with other apparatus, systems, assemblies, methods, components, materials, parts, and/or the like. In other instances, well-known structures, components, systems, materials, or operations are not specifically shown or described in detail to avoid obscuring aspects of embodiments of the invention. While the invention may be illustrated by using a particular embodiment, this is not and does not limit the invention to any particular embodiment and a person of ordinary skill in the art will recognize that additional embodiments are readily understandable and are a part of this invention.

Embodiments discussed herein can be implemented in a set of distributed computers communicatively coupled to a network (for example, the Internet). Any suitable programming language can be used to implement the routines, methods, or programs of embodiments of the invention described herein, including R, Python, C, C++, Java, JavaScript, HTML, or any other programming or scripting code, etc. Other software/hardware/network architectures may be used. Communications between computers implementing embodiments can be accomplished using any electronic, optical, radio frequency signals, or other suitable methods and tools of communication in compliance with known network protocols.

Although the steps, operations, or computations may be presented in a specific order, this order may be changed in different embodiments. In some embodiments, to the extent multiple steps are shown as sequential in this specification, some combination of such steps in alternative embodiments may be performed at the same time. The sequence of operations described herein can be interrupted, suspended, or otherwise controlled by another process, such as an operating system, kernel, etc. The routines can operate in an operating system environment or as stand-alone routines. Functions, routines, methods, steps, and operations described herein can be performed in hardware, software, firmware, or any combination thereof.

Embodiments described herein can be implemented in the form of control logic in software or hardware or a combination of both. The control logic may be stored in an information storage medium, such as a computer-readable medium, as a plurality of instructions adapted to direct an information processing device to perform a set of steps disclosed in the various embodiments. Based on the disclosure and teachings provided herein, a person of ordinary skill in the art will appreciate other ways and/or methods to implement the invention.

A “computer-readable medium” may be any medium that can contain, store, communicate, propagate, or transport the program for use by or in connection with the instruction execution system, apparatus, system, or device. The computer readable medium can be, by way of example only but not by limitation, an electronic, magnetic, optical, electromagnetic, infrared, or semiconductor system, apparatus, system, device, propagation medium, or computer memory. Such computer-readable medium shall generally be machine readable and include software programming or code that can be human readable (e.g., source code) or machine readable (e.g., object code). Examples of non-transitory computer-readable media can include random access memories, read-only memories, hard drives, data cartridges, magnetic tapes, floppy diskettes, flash memory drives, optical data storage devices, compact-disc read-only memories, and other appropriate computer memories and data storage devices.

As used herein, the terms “comprises,” “comprising,” “includes,” “including,” “has,” “having,” or any other variation thereof, are intended to cover a non-exclusive inclusion. For example, a process, product, article, or apparatus that comprises a list of elements is not necessarily limited only those elements but may include other elements not expressly listed or inherent to such process, product, article, or apparatus.

Furthermore, the term “or” as used herein is generally intended to mean “and/or” unless otherwise indicated. For example, a condition A or B is satisfied by any one of the following: A is true (or present) and B is false (or not present), A is false (or not present) and B is true (or present), and both A and B are true (or present). As used herein, a term preceded by “a” or “an” (and “the” when antecedent basis is “a” or “an”) includes both singular and plural of such term, unless clearly indicated within the claim otherwise (i.e., that the reference “a” or “an” clearly indicates only the singular or only the plural). Also, as used in the description herein and throughout the meaning of “in” includes “in” and “on” unless the context clearly dictates otherwise.

Benefits, other advantages, and solutions to problems have been described above with regard to specific embodiments. However, the benefits, advantages, solutions to problems, and any component(s) that may cause any benefit, advantage, or solution to occur or become more pronounced are not to be construed as a critical, required, or essential feature or component.

What is claimed is:

1. A method of automatically creating cases in a shipping management system, the method comprising:
receiving event and exception information relating to a plurality of shipments;
normalizing the event and exception information relating to the plurality of shipments;
for a first shipment, determining an exception cause by applying the respective normalized event and exception information to a first machine learning model trained to output an exception cause;
for the first shipment, determining an exception disposition by applying the normalized event and exception information to a second machine learning model trained to output an exception disposition; and
automatically creating a case for the first shipment by applying one or more case rules to the event and exception information, the exception cause, and the exception disposition.

2. The method of claim 1, further comprising tracking the plurality of shipments to receive new event and exception information.

3. The method of claim 2, wherein each of the plurality of shipments has a unique identifier in the shipping management system, and wherein the plurality of shipments are tracked using the respective unique identifier.

4. The method of claim 1, wherein the first and second machine learning models are trained using historical shipping data.

5. The method of claim 1, wherein the received event and exception information is received from a plurality of different carriers.

6. The method of claim 1, wherein input data is applied to the first and second machine learning models, and wherein the input data includes one or more of the normalized event information, the normalized exception information, information relating to a predictive exception, and information relating to previous events for a respective shipment.

7. The method of claim 1, further comprising automatically marking the created case as resolved by determining that criteria triggering the case creation are no longer true.

8. A system for automatically creating cases in a shipping management system, the system comprising:
a processor; and
a non-transitory computer readable medium storing instructions translatable by the processor, the instructions when translated by the processor perform:
receiving event and exception information relating to a plurality of shipments;
normalizing the event and exception information relating to the plurality of shipments;
for a first shipment, determining an exception cause by applying the respective normalized event and exception information to a first machine learning model trained to output an exception cause;
for the first shipment, determining an exception disposition by applying the normalized event and exception information to a second machine learning model trained to output an exception disposition; and
automatically creating a case for the first shipment by applying one or more case rules to the event and exception information, the exception cause, and the exception disposition.

9. The system of claim 8, further comprising tracking the plurality of shipments to receive new event and exception information.

10. The system of claim 9, wherein each of the plurality of shipments has a unique identifier in the shipping management system, and wherein the plurality of shipments are tracked using the respective unique identifier.

11. The system of claim 8, wherein the first and second machine learning models are trained using historical shipping data.

12. The system of claim 8, wherein the received event and exception information is received from a plurality of different carriers.

13. The system of claim 8, wherein input data is applied to the first and second machine learning models, and wherein the input data includes one or more of the normalized event information, the normalized exception information, information relating to a predictive exception, and information relating to previous events for a respective shipment.

14. The system of claim 8, further comprising automatically marking the created case as resolved by determining that criteria triggering the case creation are no longer true.

15. A computer program product comprising a non-transitory computer readable medium storing instructions translatable by a processor, the instructions when translated by the processor perform, in a shipping management system:
receiving event and exception information relating to a plurality of shipments;
normalizing the event and exception information relating to the plurality of shipments;
for a first shipment, determining an exception cause by applying the respective normalized event and exception information to a first machine learning model trained to output an exception cause;
for the first shipment, determining an exception disposition by applying the normalized event and exception information to a second machine learning model trained to output an exception disposition; and
automatically creating a case for the first shipment by applying one or more case rules to the event and exception information, the exception cause, and the exception disposition.

16. The computer program product of claim 15, further comprising tracking the plurality of shipments to receive new event and exception information.

17. The computer program product of claim 15, wherein the first and second machine learning models are trained using historical shipping data.

18. The computer program product of claim 15, wherein the received event and exception information is received from a plurality of different carriers.

19. The computer program product of claim 15, wherein input data is applied to the first and second machine learning models, and wherein the input data includes one or more of the normalized event information, the normalized exception information, information relating to a predictive exception, and information relating to previous events for a respective shipment.

20. The computer program product of claim 15, further comprising automatically marking the created case as resolved by determining that criteria triggering the case creation are no longer true.
